(19) United States
(12) Patent Application Publication
(10) Pub. No.: US 2019/0210308 A1
(43) Pub. Date: Jul. 11, 2019

(54) METHOD FOR REPAIRING A COMPOSITE STRINGER WITH A COMPOSITE REPAIR CAP

(71) Applicant: BOMBARDIER INC., Dorval (CA)

(72) Inventor: Jean-Philippe MAROUZÉ, Montreal (CA)

(21) Appl. No.: 16/336,253

(22) PCT Filed: Sep. 26, 2017
(86) PCT No.: PCT/IB2017/055854

§ 371 Date: Mar. 25, 2019

Related U.S. Application Data
(60) Provisional application No. 62/400,233, filed on Sep. 27, 2016.

(51) Int. Cl. B29C 73/10; B64F 5/40; B64C 1/06

(52) U.S. Cl. CPC B29C 73/10; B64C 2001/0072; B64C 1/064; B64F 5/40

(57) ABSTRACT

Methods and composite repair caps (26) for repairing composite stringers (12) of structures (10) of mobile platforms are disclosed. In one exemplary embodiment, a stringer repair method includes overlaying a pre-cured composite repair cap on an outer surface (22) of the composite stringer so that the composite repair cap extends over a damaged portion (12A) of the composite stringer. The composite repair cap is then secured to the composite stringer to permit load transfer between the composite stringer and the composite repair cap.

### CROSS-REFERENCE TO RELATED APPLICATION(S)

The present application claims priority to U.S. Provisional Patent Application No. 62/400,233 filed on Sep. 27, 2016, the entire contents of which are hereby incorporated herein by reference.

### TECHNICAL FIELD

The disclosure relates generally to repairing structural components made of composite materials, and more particularly to repairing composite stringers of structures of aircraft and other mobile platforms.

### BACKGROUND OF THE ART

The use of composite materials is increasing in several industries. Some commercial aircraft incorporate components such as aircraft skins and other structural components such as stringers that are made from composite materials due to their favorable mechanical properties and reduced weight. During manufacturing or during service, composite stringers of aircraft can be damaged due to impact and may need to be repaired. Traditional composite repair methods can be relatively complex and time consuming. Improvement is desirable.

### SUMMARY

In one aspect, the disclosure describes a method for repairing a composite stringer of a structure of a mobile platform. The method comprises:

after an identification of a damaged portion of the composite stringer, overlaying a pre-cured composite repair cap on an outer surface of the composite stringer so that the pre-cured composite repair cap extends over the damaged portion of the composite stringer; and

securing the pre-cured composite repair cap to the composite stringer to permit load transfer between the composite stringer and the pre-cured composite repair cap.

The pre-cured composite repair cap may comprise an inner surface complementary to a baseline shape of the outer surface of the composite stringer.

The method may comprise removing material from the damaged portion of the composite stringer before overlaying the pre-cured composite repair cap on the outer surface of the composite stringer.

The method may comprise securing the pre-cured composite repair cap to the composite stringer using a plurality of fasteners extending through the outer surface of the composite stringer.

The composite stringer may have an omega configuration.

The composite stringer may have a delta configuration.

The composite stringer may have a hollow configuration.

Embodiments may include combinations of the above features.

In another aspect, the disclosure describes a repaired hollow composite stringer of a structure of a mobile platform. The repaired hollow composite stringer comprises:

a composite stringer wall defining a hollow internal cavity, the composite stringer wall having an outer surface defining a baseline outer shape of the hollow composite stringer, the composite stringer wall having a damaged portion; and

a composite repair cap overlaying the outer surface of the composite stringer wall so that the composite repair cap extends over the damaged portion of the composite stringer wall, the composite repair cap being secured the to the composite stringer wall to permit load transfer between the composite stringer wall and the composite repair cap.

The composite repair cap may comprise an inner surface complementary to the baseline outer shape defined by the outer surface of the composite stringer wall.

The composite repair cap may be secured the to the composite stringer wall with plurality of fasteners extending through the composite stringer wall.

The composite stringer wall may define an omega configuration of the hollow composite stringer.

The composite stringer wall may define a delta configuration of the hollow composite stringer.

The composite repair cap may be of the same material type and construction as the composite stringer wall.

The composite cap wall may comprise one or more fabric plies having unidirectional fibers.

Embodiments may include combinations of the above features.

In a further aspect, the disclosure describes a pre-cured composite repair cap for repairing a hollow composite stringer of a structure of a mobile platform. The pre-cured composite repair cap comprises:

a composite cap wall having an inner surface complementary to an outer surface of a hollow composite stringer defining a baseline outer shape of the hollow composite stringer, the composite cap wall being configured to overlay the outer surface of the composite stringer and extend over a damaged portion of the hollow composite stringer.

The composite cap wall may comprise a plurality of holes extending therethrough for accommodating respective fasteners.

The inner surface of the composite cap wall may be complementary to an omega configuration of the hollow composite stringer.

The inner surface of the composite cap wall may be complementary to a delta configuration of the hollow composite stringer.

The composite cap wall may comprise one or more fabric plies having unidirectional fibers.

Embodiments may include combinations of the above features.

In a further aspect, the disclosure describes a method for manufacturing a pre-cured composite repair cap configured to overlay and be secured to a portion of a damaged composite stringer of a structure of a mobile platform. The method comprises:

forming the composite repair cap by using another composite stringer of a substantially same baseline shape and size as the damaged composite stringer as a mold; and

curing the composite repair cap.

The other composite stringer may be unsuitable for service on the structure of the mobile platform.

The method may comprise forming a plurality of holes through the composite repair cap to accommodate a plurality of respective fasteners.

The method may comprise using an outer surface of the other composite stringer as a mold surface.

The other composite stringer may have an omega configuration.

The other composite stringer may have a delta configuration.

The other composite stringer may have a hollow configuration.

The other composite stringer may be of the same material type and construction as the damaged composite stringer.

Embodiments may include combinations of the above features.

In a further aspect, the disclosure describes an aircraft structure comprising a repaired composite stringer as described herein.

In a further aspect, the disclosure describes an aircraft structure comprising a composite repair cap as described herein.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a partial perspective view of the inside of an exemplary structure of a mobile platform comprising a plurality of composite stringers;

FIG. 2A shows a cross-sectional profile of an exemplary stringer of the structure of FIG. 1 having an omega configuration;

FIG. 2B shows a cross-sectional profile of another exemplary stringer of the structure of FIG. 1 having a delta configuration;

FIG. 3 is a perspective view of an exemplary repaired composite stringer;

FIGS. 4A and 4B are cross-sectional views of the repaired composite stringer of FIG. 3 taken along lines A-A and B-B respectively;

FIG. 5 is a perspective view of an exemplary composite repair cap for repairing the composite stringer of FIG. 3;

FIG. 6 is a diagram illustrating a method for repairing the composite stringer of FIG. 3;

FIG. 7 is a diagram illustrating a method for manufacturing the composite repair cap of FIG. 5; and

FIG. 8 is a schematic representation of an exemplary lay-up for manufacturing the composite repair cap of FIG. 5.

### DETAILED DESCRIPTION

This disclosure relates to repairing of composite components such as stringers of structures of aircraft and other mobile platforms (e.g., vehicles). For the purpose of the present disclosure, the term “composite” is intended to encompass fiber-reinforced composite materials (e.g., polymers) and advanced composite materials also known as advanced polymer matrix composites which generally comprise high strength fibers bound together by a matrix material suitable for use in aircraft or other structural parts. For example, such composite materials may include fiber reinforcement materials such as carbon, aramid and/or glass fibers embedded into a thermosetting or thermoplastic matrix material. It is understood that aspects of this disclosure may be applicable to the repair of stringers or other components that are made from other non-metallic materials.

In various aspects, the present disclosure describes methods and devices for repairing composite stringers that are part of structures of mobile platforms. In some embodiments, the repair methods disclosed herein make use of a composite repair cap configured to overlay part of a damaged composite stringer and be secured to the damaged composite stringer in order to permit load transfer between the damaged composite stringer and the composite repair cap. For example, the composite repair cap may serve as local structural reinforcement in and/or near a damaged portion of the composite stringer.

In some embodiments, aspects of the present disclosure may facilitate relatively simplified, efficient and/or cost-reducing methods for repairing composite stringers of structures of mobile platforms. Even though the following disclosure refers mainly to the repair of a stringer as an example, it is understood that aspects of this disclosure may also be applicable to repairing other composite structural components of aircraft or other mobile platforms.

Aspects of various embodiments are described through reference to the drawings.

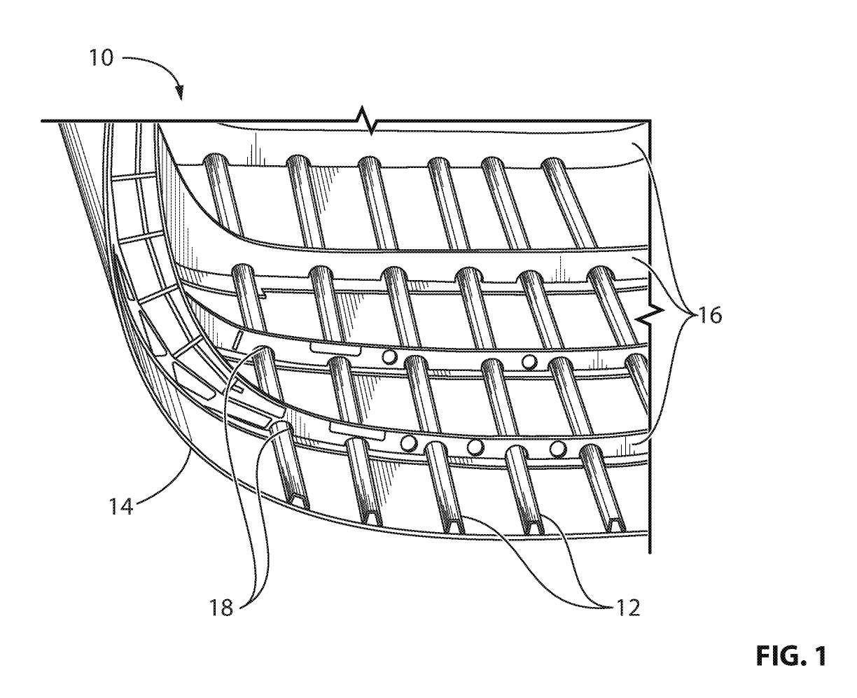

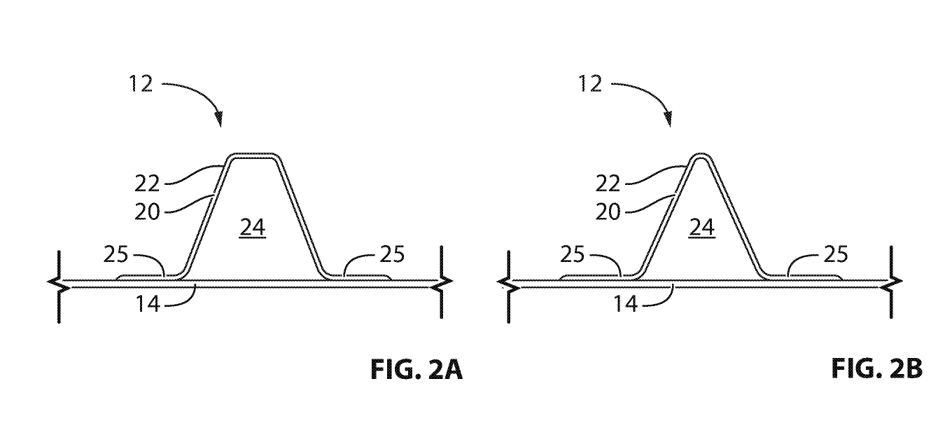

FIG. 1 is a perspective view of the inside of part of an aircraft structure 10 (e.g., fuselage) comprising a plurality of exemplary longitudinal composite stringers 12. In some embodiments, stringers 12 may be made from any suitable non-metallic material(s). Aircraft structure 10 may comprise a skin 14 internally supported by transverse frames 16 and composite stringers 12. Skin 14 may comprise a composite or other suitable material. Frames 16 and composite stringers 12 may be fastened to skin 14 and provide support for the aerodynamic and/or pressurization loads acting on skin 14. Composite stringers 12 may, for example, be fastened to skin 14 by riveting or by bonding with adhesive(s). Composite stringers 12 may have a cross-sectional shape having a substantial height to provide a sufficient moment of inertia to help withstand loads. As explained below, composite stringers 12 may have a hollow configuration where a hollow internal cavity (see item 24 shown in FIGS. 2A and 2B) extends longitudinally along each stringer 12. For example, each stringer 12 may have a transverse “delta” (i.e., Δ) shape/cross-sectional profile or a transverse “omega” (i.e., Ω, hat-shaped) shape/cross-sectional profile, which are considered to be relatively complex shapes for a composite stringer especially when stringers 12 follow the curvature of a region of skin 14 that has a double contour (i.e., is doubly curved). Accordingly, stringers 12 may have a relatively complex shape which can make the use of traditional composite repair methods that include in-situ curing difficult and time consuming.

FIG. 2A shows a cross-sectional profile of an exemplary composite stringer 12 of aircraft structure 10 having an omega configuration. FIG. 2B shows a cross-sectional profile of another exemplary composite stringer 12 of the aircraft structure 10 having a delta configuration. Aircraft structure 10 may comprise composite stringers 12 having an omega configuration, composite stringers 12 having an omega configuration, or, a combination of composite stringers 12 of different configurations (e.g., both omega and delta configurations).

In various embodiments, composite stringer 12 may comprise composite stringer wall 20 defining hollow internal cavity 24. Composite stringer wall 20 may have an outer surface 22 defining a baseline outer shape of composite stringer 12. For the purpose of the present disclosure, the term “baseline shape” is intended to represent an undamaged (e.g., undented, as-manufactured) shape of composite stringer 12 as installed in aircraft structure 10. In other words, the baseline outer shape of stringer 12 is intended to represent the outer shape of stringer 12 defined by outer surface 22 before the occurrence of any damage (e.g., dent(s)) causing deformation of composite stringer wall 20. Composite stringer 12 may comprise foot sections 25 (e.g., flanges) which may serve to interface with skin 14 and secure composite stringer 12 to skin 14 via suitable means. Foot sections 25 may be disposed on either sides of cavity 24 of composite stringer 12 as shown in FIGS. 2A and 2B. In some embodiments, foot sections 25 may be part of (i.e., integrally formed with) composite stringer wall 20 as a unitary construction.

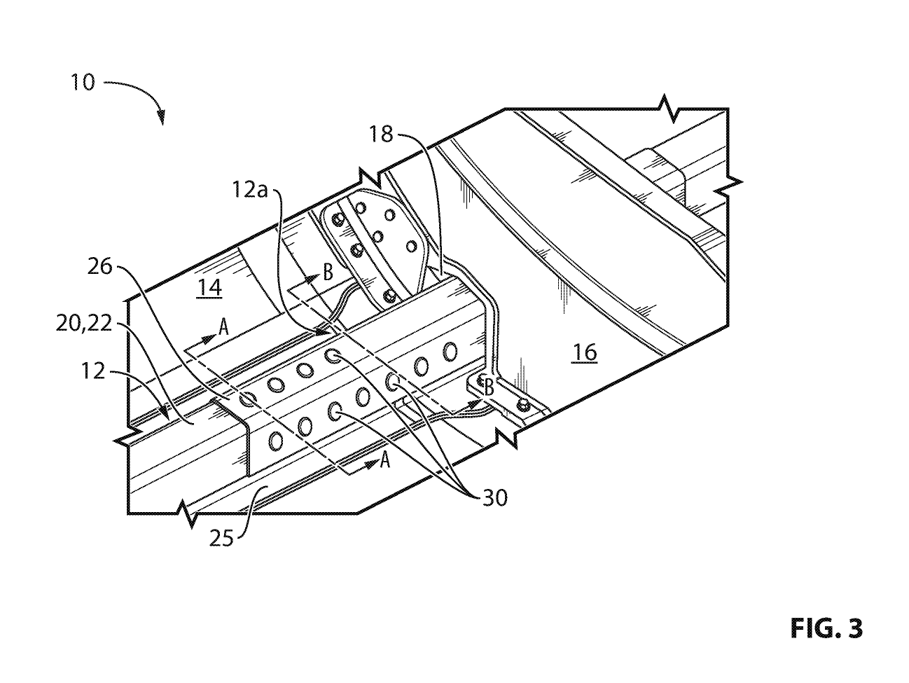

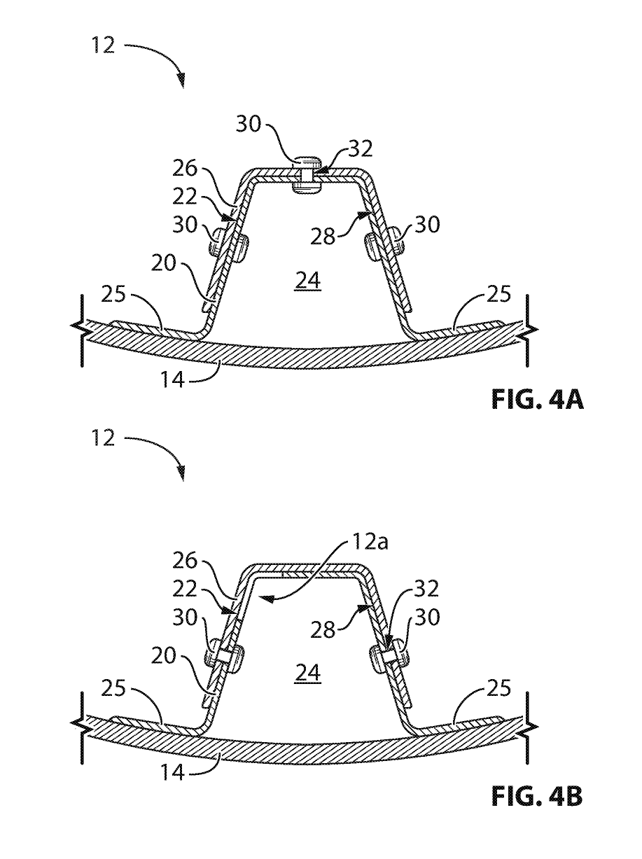

FIG. 3 is a perspective view of an exemplary repaired composite stringer 12 which may be part of aircraft structure 10. Even though the exemplary composite stringer 12 shown in FIG. 3 and in the subsequent figures has an omega configuration, it is understood that aspects of the present disclosure may be applicable to other types of composite stringers including those having a hollow (e.g., delta) configuration. For example, composite stringer 12 may be of a type other than a blade stringer. As shown in FIG. 2A, composite stringer 12 may comprise composite stringer wall 20 defining hollow internal cavity 24 (see FIG. 2A) and outer surface 22 defining a baseline outer shape of composite stringer 12. Outer surface 22 may face outwardly from skin 14 and may therefore be exposed to the interior of the fuselage of the associate aircraft, for example. Accordingly, in some installations, there may be potential for outer surface 22 and consequently composite stringer wall 20 to get damaged (e.g., dented) due to impact in some situations. An exemplary damaged portion of composite stringer 12 is indicated generally at 12A in FIG. 3 and shown as being covered by composite repair cap 26. Damaged portion 12A of composite stringer 12 is shown in FIG. 4B where damaged material has been removed from composite stringer 12.

Composite stringer 12 may be repaired using composite repair cap 26 overlaying outer surface 22 of composite stringer wall 20 so that composite repair cap 26 extends over damaged portion 12A of composite stringer wall 20. Composite repair cap 26 may be secured to composite stringer wall 20 using any suitable means to permit load transfer between composite stringer wall 20 and composite repair cap 26. Accordingly, composite repair cap 26 may serve as local structural reinforcement (e.g., a structural brace) in the region of damaged portion 12A. For example, composite repair cap 26 may serve to restore the structural performance of composite stringer 12, which may have otherwise been compromised due to the damage. The length (i.e., longitudinal dimension) of composite repair cap 26 may be selected based on one or more characteristics (e.g., extent, severity) of damaged portion 12A.

FIGS. 4A and 4B are cross-sectional views of the repaired composite stringer 12 of FIG. 3 taken along lines A-A and B-B respectively. Composite repair cap 26 may comprise inner surface 28 having a shape that is complementary to the baseline outer shape of composite stringer 12 defined by outer surface 22 of composite stringer wall 20. In various embodiments, composite repair cap 26 may be configured to overlay one or more portions of outer surface 22. For example, inner surface 28 of composite repair cap 26 may be in contact with the one or more portions of outer surface 22. For example, inner surface 28 may be configured so that composite repair cap 26 may be in a mating relationship with the outside of composite stringer 12 when installed thereon.

In some embodiments, composite repair cap 26 may be configured to overlay a portion of outer surface 22 excluding foot portions 25 as illustrated in

FIGS. 4A and 4B. Alternatively, in some embodiments, composite repair cap 26 may be configured to overlay a portion of outer surface 22 that includes at least part of one or more foot portions 25. The amount of outer surface 22 of composite stringer 12 covered by composite repair cap 26 may be selected based on one or more characteristics (e.g., extent, severity) of damaged portion 12A of composite stringer 12.

In various embodiments, composite repair cap 26 may be secured to composite stringer 12 using any suitable means including one or more fasteners (e.g., rivets, bolts) and/or adhesive(s) suitable for securing composite parts (e.g., laminates) together. For example, as illustrated in FIGS. 3, 4A and 4B, composite repair cap 26 may be secured to composite stringer wall 20 with a plurality of fasteners 30. Fasteners 30 may extend through holes 32 extending through composite repair cap 26 and through composite stringer wall 20. In some embodiments, holes 32 may be oriented generally perpendicular to outer surface 22 at their respective locations. The type, number and spacing of fasteners 30 may depend on the specific application. For example, one or more fasteners 30 may be located in a top portion of composite repair cap 26. Alternatively or in addition, one or more fasteners 30 may be located in one or more side portions of composite repair cap 26. In some embodiments, fasteners 30 may be suitable blind fasteners.

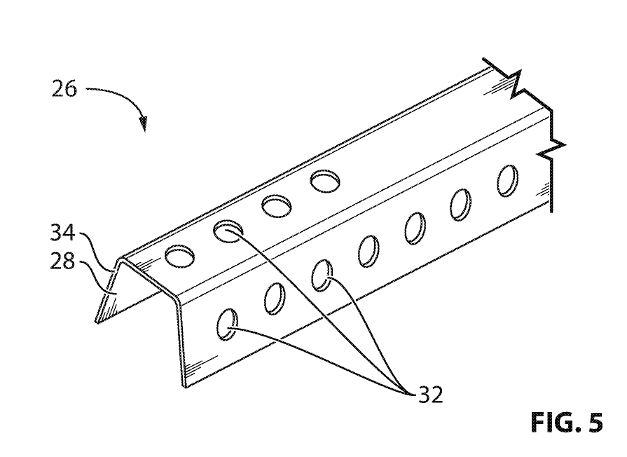

FIG. 5 is a perspective view of part of composite repair cap 26 shown in isolation. FIG. 5 shows composite cap wall 34 having inner surface 28 of a shape that is complementary to outer surface 22 of composite stringer 12 and defining a baseline outer shape of composite stringer 12. Composite cap wall 34 may be configured to overlay outer surface 22 of composite stringer 12 and be secured thereto. Accordingly, composite repair cap 26 may extend over damaged portion 12A of composite stringer 12 and provide local structural reinforcement to composite stringer 12.

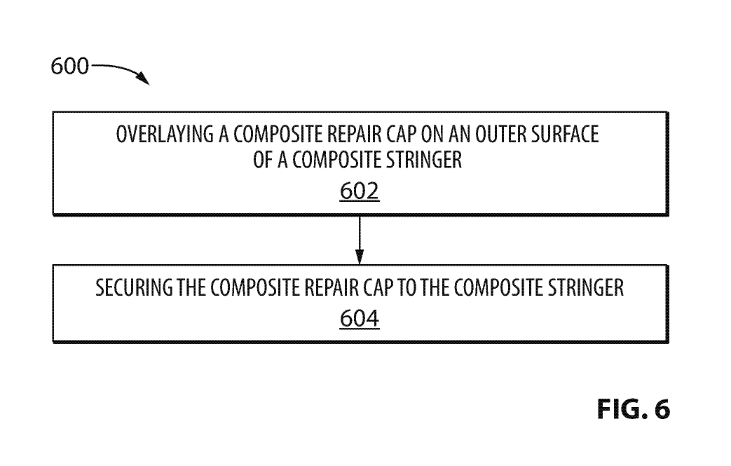

FIG. 6 is a diagram illustrating method 600 for repairing composite stringer 12. In some embodiments, method 600 may permit the repair of composite stringer 12 using composite repair cap 26 described above. Accordingly, aspects of composite repair cap 26 and of repaired composite stringer 12 described above may also be applicable to some embodiments of method 600.

In some embodiments, method 600 may eliminate the need for machining a (e.g., scarf) area in damage portion 12A and attempting to match plies with repair plies where necessary and/or match the curvature of composite stringer 12 as can be done in traditional composite repair methods. Depending on the type of damage, some material of composite stringer 12 in damaged portion 12A may need to be removed before the application of composite repair cap 26 in order to remove material that has been deformed to extend outwardly from the baseline outer shape (e.g., baseline cross-sectional profile) of composite stringer 12 so that such protruding material will not interfere with the overlaying of the composite repair cap 26 on outer surface 22 of composite stringer 12. In some embodiments, machining or other processing to remove material below the baseline outer shape of composite stringer 12 may not be required. In some situations, depending on the type of damage, it may be desirable to remove damaged material from composite stringer 12 to remove delaminations and provide a clean zone for repair as shown in FIG. 4B where damaged material has been removed from composite stringer 12.

In various embodiments, method 600 may comprise: after an identification of damaged portion 12A of composite stringer 12, overlaying composite repair cap 26 on outer surface 22 of composite stringer 12 so that composite repair cap 26 extends over damaged portion 12A of composite stringer 12 (see block 602); and securing composite repair cap 26 to composite stringer 12 to permit load transfer between composite stringer 12 and composite repair cap 26. In some embodiments, method 600 or part(s) thereof may be performed in-situ, i.e., while composite stringer 12 is still attached to aircraft structure 10. Composite repair cap 26 may be formed (i.e., pre-shaped) and fully cured (i.e., pre-cured) before overlaying composite repair cap 26 on outer surface 22 of composite stringer 12.

In some embodiments, method 600 may comprise removing material from damaged portion 12A of composite stringer 12 before overlaying composite repair cap 26 on outer surface 22 of composite stringer 12.

In some embodiments, method 600 may comprise securing composite repair cap 26 to composite stringer 12 using a plurality of fasteners 30 extending through outer surface 22 of composite stringer 12.

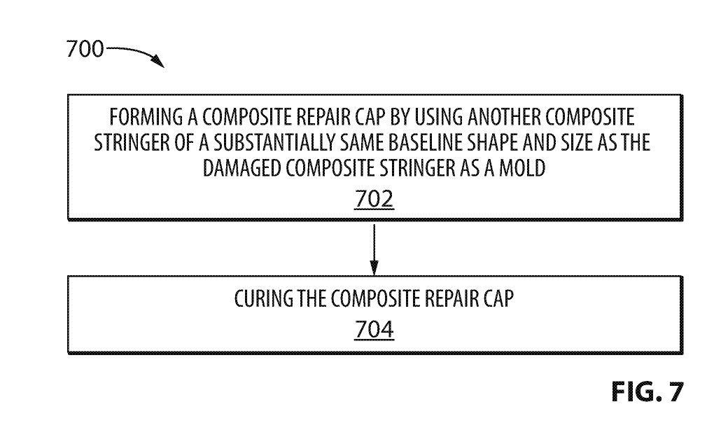

FIG. 7 is a diagram illustrating method 700 for manufacturing composite repair cap 26 configured to overlay and be secured to a portion of damaged composite stringer 12 of aircraft structure 10. Aspects of composite repair cap 26 and of repaired stringer 12 described above may also be applicable to some embodiments of method 700.

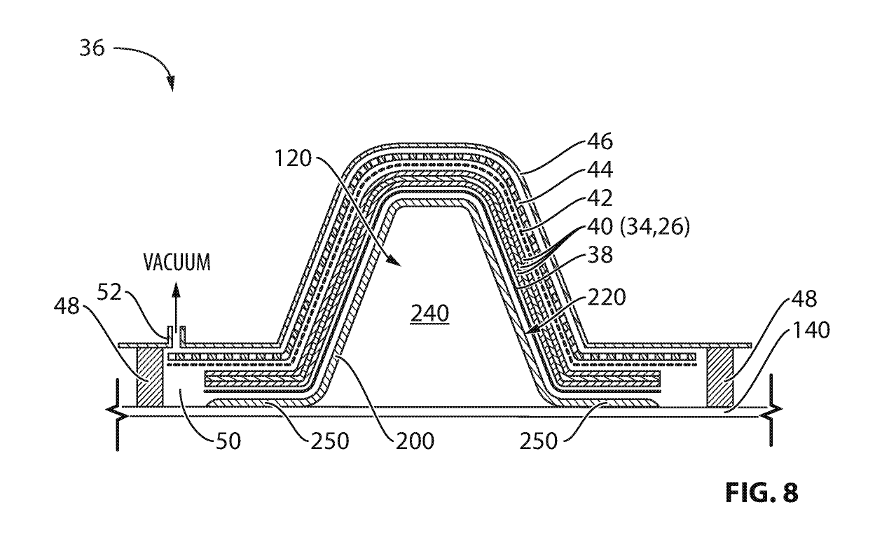

FIG. 8 is a schematic representation of an exemplary layup 36 for manufacturing composite repair cap 26.

In reference to FIGS. 7 and 8, method 700 may comprise: forming composite repair cap 26 by using another composite stringer 120 of a substantially same baseline shape and size as damaged composite stringer 12 as a mold (see block 702 in FIG. 7); and curing composite repair cap 26 (see block 704 in FIG. 7).

In some embodiments of method 700, other composite stringer 120 may be unsuitable for service on aircraft structure 10. For example, even though other composite stringer 120 may be of substantially identical shape to the baseline shape of damaged composite stringer 12 and may have been manufactured with the intention of being used for service, other composite stringer 120 may have been deemed not suitable for service at the time of quality assurance inspection for one or more reasons. For example, even though other composite stringer 120 may be unsuitable for service (e.g., because of an internal defect), it may still be suitable for use as a mold for forming composite repair cap 26.

In reference to FIG. 8, other composite stringer 120 is illustrated as being used as a mold during a process for forming composite repair cap 26. Since other composite stringer 120 is substantially identical to damaged composite stringer 12 in appearance, the elements of other composite stringer 120 are identified using the same reference numerals as for damaged composite stringer 12 except for the addition of a trailing zero “0”. Outer surface 220 of other composite stringer 120 may be used as a mold surface. In some embodiments, other skin 140 may also be used for the manufacturing of composite repair cap 26. In some embodiments, other composite stringer 120 and other skin 140 may be attached together due to having been co-cured. Alternatively, other skin 140 and other composite stringer 120 may have been manufactured as separate components that have been subsequently attached together by bonding for example.

Layup 36 may comprise release medium 38 disposed between outer surface 220 of other composite stringer 120 and one or more plies 40 used to form composite cap wall 34 of composite repair cap 26. Release medium 38 may include a film of oil, grease, or other polymer having relatively low strength. In some embodiments, release medium 38 may comprise a cohesively formed plastic film that does not readily adhere to other polymers or other type of known or other release medium. For example, release medium 38 may be configured to not chemically bond to the other composite stringer 120 so that it may be easily removed by peeling and facilitate the removal of composite repair cap 26 after forming and/or curing. In some embodiments, release medium 38 may comprise a

Polytetrafluoroethylene (PTFE) coated fibreglass fabric of the type known under the trade name RELEASE EASE.

In some embodiments, plies 40 used to manufacture composite repair cap 26 may be of the same type, material, stacking sequence and number as those used to manufacture damaged composite stringer 12 so that composite repair cap 26 may be of the same material type(s) and construction as damaged composite stringer 12. This may result in the material of composite repair cap 26 having similar mechanical properties (e.g., stiffness) as those of the material of damaged composite stringer 12 and this may be advantageous in some situations. Accordingly, in some embodiments, composite repair cap 26, other composite stringer 120 and damaged composite stringer 12 may all be composite laminates made of the same material(s) and of the same construction (e.g., same ply stacking sequence). In some embodiments, plies 40 may be of the types that are pre-impregnated with a suitable matrix material such as epoxy. Alternatively, composite repair cap 26 may be manufactured using a suitable resin infusion process. It is understood that other suitable composites manufacturing methods could be used to manufacture composite repair cap 26.

In some embodiments, composite repair cap 26 may comprise one or more fabric plies having unidirectional fibers (i.e., unidirectional fabric plies). In some embodiments, composite repair cap 26 be made using only unidirectional fabric plies. In some embodiments, composite repair cap 26 be made using at least some woven fabric plies.

In some embodiments, layup 36 may also comprise porous film 42, breather 44 and vacuum barrier 46. Vacuum barrier 46 may be substantially hermetically sealed with other skin 140 via one or more suitable sealing members 48, which may comprise a suitable sealant or double-sided tape, to define an evacuatable volume 50 between vacuum barrier 46 and the mold. Vacuum barrier 46 may comprise a suitable polymer flexible sheet and may be of the type(s) suitable for use as flexible bagging membranes (i.e., vacuum bags). Vacuum barrier 46 may be substantially gas-impermeable. The evacuation of evacuatable volume 50 may be achieved by the application of suction via vacuum port 52 to thereby compress plies 40 against the mold (i.e., other composite stringer 120). Heat may also be applied to plies 40 by any suitable means while applying suction to evacuatable volume 50 to thereby at least partially consolidate composite repair cap 26.

In some embodiments, porous film 42 may be of suitable type configured to facilitate the debulking of plies 40 during the evacuation of evacuatable volume 50 and facilitate the release of composite repair cap 26 from layup 36. In some embodiments, porous film 42 may comprise PTFE coated fibreglass fabric of the type known under the trade name RELEASE EASE.

Breather 44 may be disposed in evacuatable volume 50 between porous film 42 and vacuum barrier 46. Breather 44 may be of suitable type to provide passage space for gas/air drawn under vacuum from different regions of evacuatable volume 50 toward vacuum port 52.

In various embodiments, composite repair cap 26 may be formed (i.e., pre-shaped) and fully cured (i.e., pre-cured) before installation (e.g., overlaying and securing) onto damaged composite stringer 12. In some embodiments, composite repair cap 26 may be cured using autoclave processing or other suitable method. Composite repair cap 26 may have an “offset” shape configured to fit closely over damaged composite stringer 12 by virtue of using other composite stringer 120 as a mold.

In some embodiments, composite repair cap 26 may be manufactured to a length that is greater than required for repairing composite stringer 12 and subsequently cut/trimmed to the correct size required for repair. For example, composite repair cap 26 could be pre-manufactured to a length that substantially matches an entire length of composite stringer 12 and kept on-hand in case a part of it is needed for repair. When needed, an appropriate portion of the longer composite repair cap 26 may be cut and used to repair a corresponding portion (e.g., of matching shape/curvature) of composite stringer 12 as needed. In some situations, this approach may promote a relatively simple and efficient repair method.

In some embodiments, method 700 for manufacturing composite repair cap 26 may comprise forming a plurality of holes 32 (shown in FIG. 5) through composite repair cap 26 for accommodating a plurality of respective fasteners 30 (shown in FIG. 3). In some embodiments, composite repair cap 26 (e.g., external surface thereof) may be painted before installation onto damaged composite stringer 12. In some embodiments, faying surface sealant may be applied between mating surfaces of composite repair cap 26 and damaged composite stringer 12. In some embodiments, suitable shim(s) may be applied between mating surfaces of composite repair cap 26 and damaged composite stringer 12.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. The present disclosure may be embodied in other specific forms without departing from the subject matter of the claims. Also, one skilled in the relevant arts will appreciate that while the devices disclosed and shown herein may comprise a specific number of elements/components, the devices could be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

1. A method for repairing a composite stringer of a structure of a mobile platform, the method comprising:
after an identification of a damaged portion of the composite stringer, overlaying a pre-cured composite repair cap on an outer surface of the composite stringer so that the pre-cured composite repair cap extends over the damaged portion of the composite stringer; and
securing the pre-cured composite repair cap to the composite stringer to permit load transfer between the composite stringer and the pre-cured composite repair cap.

2. The method as defined in claim 1, wherein the pre-cured composite repair cap comprises an inner surface complementary to a baseline shape of the outer surface of the composite stringer.

3. The method as defined in claim 1, comprising removing material from the damaged portion of the composite stringer before overlaying the pre-cured composite repair cap on the outer surface of the composite stringer.

4. The method as defined in claim 1, comprising securing the pre-cured composite repair cap to the composite stringer using a plurality of fasteners extending through the outer surface of the composite stringer.

5. The method as defined in claim 1, wherein the composite stringer has an omega configuration.

6. The method as defined in claim 1, wherein the composite stringer has a delta configuration.

7. The method as defined in claim 1, wherein the composite stringer has a hollow configuration.

8. A repaired hollow composite stringer of a structure of a mobile platform, the repaired hollow composite stringer comprising:
a composite stringer wall defining a hollow internal cavity, the composite stringer wall having an outer surface defining a baseline outer shape of the hollow composite stringer, the composite stringer wall having a damaged portion; and
a composite repair cap overlaying the outer surface of the composite stringer wall so that the composite repair cap extends over the damaged portion of the composite stringer wall, the composite repair cap being secured the to the composite stringer wall to permit load transfer between the composite stringer wall and the composite repair cap.

9. The repaired hollow composite stringer as defined in claim 8, wherein the composite repair cap comprises an inner surface complementary to the baseline outer shape defined by the outer surface of the composite stringer wall.

10. The repaired hollow composite stringer as defined in claim 8, wherein the composite repair cap is secured the to the composite stringer wall with plurality of fasteners extending through the composite stringer wall.

11. The repaired hollow composite stringer as defined in claim 8, wherein the composite stringer wall defines an omega configuration of the hollow composite stringer.

12. The repaired hollow composite stringer as defined in claim 8, wherein the composite stringer wall defines a delta configuration of the hollow composite stringer.

13. The repaired hollow composite stringer as defined in claim 8, wherein the composite repair cap is of the same material type and construction as the composite stringer wall.

14. The repaired hollow composite stringer as defined in claim 8, wherein the composite cap wall comprises one or more fabric plies having unidirectional fibers.

15. An aircraft structure comprising the repaired hollow composite stringer as defined in claim 8.

16. A pre-cured composite repair cap for repairing a hollow composite stringer of a structure of a mobile platform, the pre-cured composite repair cap comprising:
a composite cap wall having an inner surface complementary to an outer surface of a hollow composite stringer defining a baseline outer shape of the hollow composite stringer, the composite cap wall being configured to overlay the outer surface of the composite stringer and extend over a damaged portion of the hollow composite stringer.

17. The pre-cured composite repair cap as defined in claim 16, wherein the composite cap wall comprises a plurality of holes extending therethrough for accommodating respective fasteners.

18. The pre-cured composite repair cap as defined in claim 16, wherein the inner surface of the composite cap wall is complementary to an omega configuration of the hollow composite stringer.

19. The pre-cured composite repair cap as defined in claim 16, wherein the inner surface of the composite cap wall is complementary to a delta configuration of the hollow composite stringer.

20. The pre-cured composite repair cap as defined in claim 16, wherein the composite cap wall comprises one or more fabric plies having unidirectional fibers.

21.-28. (canceled)
